(19) United States
(12) Patent Application Publication
(10) Pub. No.: US 2015/0046537 A1
(43) Pub. Date: Feb. 12, 2015

(54) RETRIEVING VIDEO ANNOTATION METADATA USING A P2P NETWORK AND COPYRIGHT FREE INDEXES

(71) Applicant: VDOQWEST, INC., A DELAWARE CORPORATION, Saratoga, CA (US)

(72) Inventor: Shlomo Selim Rakib, Saratoga, CA (US)

(21) Appl. No.: 14/523,914

(22) Filed: Oct. 26, 2014

Related U.S. Application Data
(63) Continuation-in-part of application No. 12/754,710, filed on Apr. 6, 2010, now abandoned.
Application No. 12/754,710 is a continuation-in-part of application No. 12/423,752, filed on Apr. 14, 2009, now Pat. No. 8,875,212.
Application No. 12/423,752 is a continuation-in-part of application No. 14/269,333, filed on May 5, 2014.
Application No. 14/269,333 is a division of application No. 12/349,473, filed on Jan. 6, 2009, now Pat. No. 8,719,288.
Application No. 12/349,473 is a continuation-in-part of application No. 12/349,469, filed on Jan. 6, 2009, now Pat. No. 8,358,840.
Application No. 12/349,469 is a continuation-in-part of application No. 11/944,290, filed on Nov. 21, 2007, now Pat. No. 8,170,392.
(60) Provisional application No. 61/045,278, filed on Apr. 15, 2008.

(51) Int. Cl. H04L 29/08; G06F 17/30; H04L 29/06

(52) U.S. Cl. CPC H04L 67/104; H04L 65/60; G06F 17/30867
USPC 709/204

(57) ABSTRACT

Video programs (media) are analyzed, often using computerized image feature analysis methods. Annotator index descriptors or signatures that are indexes to specific video scenes and items of interest are determined, and these in turn serve as an index to annotator metadata (often third party metadata) associated with these video scenes. The annotator index descriptors and signatures, typically chosen to be free from copyright restrictions, are in turn linked to annotator metadata, and then made available for download on a P2P network. Media viewers can then use processor equipped video devices to select video scenes and areas of interest, determine the corresponding user index, and send this user index over the P2P network to search for index linked annotator metadata. This metadata is then sent back to the user video device over the P2P network. Thus video programs can be enriched with additional content without transmitting any copyrighted video data.

### CROSS REFERENCE TO RELATED APPLICATIONS

This application is a continuation in part of U.S. patent application Ser. No. 12/754,710, “RETRIEVING VIDEO ANNOTATION METADATA USING A P2P NETWORK”, filed Apr. 6, 2010; this application is also a continuation in part of U.S. patent application Ser. No. 12/423,752, “Systems and methods for remote control of interactive video”, filed Apr. 14, 2009; this application is also a continuation in part of U.S. patent application Ser. No. 14/269,333, “Universal Lookup of Video-Related Data”, filed Mar. 5, 2014; application Ser. No. 14/269,333 in turn was a division of U.S. patent application Ser. No. 12/349,473, “Universal Lookup of Video-Related Data”, filed Jan. 6, 2009, now U.S. Pat. No. 8,719,288; application Ser. No. 12/349,473 was a continuation in part of U.S. patent application Ser. No. 12/349,469 “METHODS AND SYSTEMS FOR REPRESENTATION AND MATCHING OF VIDEO CONTENT” filed Jan. 6, 2009, now U.S. Pat. No. 8,358,840; application Ser. No. 12/349,473 also claimed the benefit of U.S. provisional application 61/045,278, “VIDEO GENOMICS: A FRAMEWORK FOR REPRESENTATION AND MATCHING OF VIDEO CONTENT”, filed Apr. 15, 2008; application Ser. No. 12/349,473 also claimed the benefit of U.S. patent application Ser. No. 11/944,290, “METHOD AND APPARATUS FOR GENERATION, DISTRIBUTION AND DISPLAY OF INTERACTIVE VIDEO CONTENT”, filed Nov. 21, 2007, now U.S. Pat. No. 8,170,392; the entire contents of all of these applications are incorporated herein by reference.

### BACKGROUND OF THE INVENTION

1. Field of the Invention

The invention is in the general fields of digital video information processing technology and P2P networks.

2. Description of the Related Art

The viewer of a television program or other video program (media) will often see many items of potential interest in various scenes of the media. For example, a favorite television star may be wearing an interesting item such as fashionable sunglasses, may be driving a distinctive brand of automobile, or may be traveling to an exotic location that may strike the viewer as being an interesting future vacation spot. From the standpoint of the manufacturer of the sunglasses or automobile, or a hotel owner with a hotel at that exotic location, such user interest represents a unique opportunity to provide information on these items in a context where the viewer will be in a very receptive mood.

Unfortunately, with present technology, such transient user interest often goes to waste. In order to find out more about the interesting item, the user will usually have to pause or stop viewing the video media, log onto a web browser (or open a catalog), and attempt to manually search for the item of interest, often without a full set of search criteria. That is, the viewer will often not know the name of the manufacturer, the name of the item of interest, or the geographic position of the exotic location. As a result, although the user may find many potential items of interest in a particular video media, the user will be unlikely to follow up on this interest.

At present, on video networks such as broadcast television, cable, and satellite TV, the most that can be done is to periodically interrupt the video media with intrusive commercials. Some of these commercials may have some tie-ins with their particular video media, of course, but since the commercials are shown to the viewer regardless of if the viewer has signaled actual interest in that particular product at that particular time, most commercials are wasted. Instead the viewers (users) will usually use the commercial time to think about something else, get up and get a snack, or do some other irrelevant activity.

On a second front, P2P networks have become famous (or infamous) as a way for users to distribute video information. Examples of such P2P networks include Gnutella and Freenet. Some commonly used computer programs that make use of such decentralized P2P networks include Limewire, utorrent and others. Here a user desiring to view a particular video media may initiate a search on the P2P network by, for example, entering in a few key words such as the name of the video media. In an unstructured P2P network, the searching node may simply establish communication with a few other nodes, copy the links that these other nodes have, and in turn send direct search requests to these other node links. Alternatively in a structured P2P network, the searching node may make contact with other peers that provide lookup services that allow P2P network content to be indexed by specific content and specific P2P node that has the content, thus allowing for more efficient search.

The protocols for such P2P networks are described in publications such as Taylor and Harrison, “From P2P to Web Services and Grids: Peers in a Client/Server World”, Springer (2004) and Oram “Peer-to-Peer: “Harnessing the Power of Disruptive Technologies”, O'Reilly (2001).

Once the video content has been located and downloaded, however, the P2P networks otherwise function no differently than any other media distribution system. That is, a viewer of downloaded P2P video media is no more able to quickly find out more about items of interest in the P2P video media than a viewer of any other video content. Thus owners of video media being circulated on P2P networks tend to be rather hostile to P2P networks, because opportunities to monetize the video content remain very limited.

Prior art video and image indexing methods: Schiavi, in US patent publication 2008/0126191, proposed a video indexing method that operated by capturing and storing certain video frames of a video, and using these video frames (image stills) as a method to index to certain portions of a video. Other video indexing methods were proposed by Giakoumis et. al., “Search and Retrieval of Multimedia Objects over a Distributed P2P Network for Mobile Devices”, IEEE Wireless Communications, October 2009, pages 42-48. Giakoumis teaches storing 3D models of objects in a database, and methods that match a user drawn sketch of an object of interest with this 3D model.

### BRIEF SUMMARY OF THE INVENTION

Ideally, what is needed is a way to minimize the barrier between the transient appearance of user interest in any given item in a video media, and the supplier of that particular item (or other provider of information about that item). Here, the most effective method would be a method that requires almost no effort on the part of the user, and which presents the user with additional information pertaining to the item of interest with minimal delay—either during viewing the video media itself, at the end of the video media, or perhaps offline as in the form of an email message or social network post to the user giving information about the item of interest.

At the same time, since there are many thousands of potential items of interest, and many thousands of potential suppliers of these items of interest, ideally there should be a way for a supplier or manufacturer of a particular item to be able to annotate a video media that contains the supplier's item with metadata that gives more information about the item, and make the existence of this annotation metadata widely available to potential media viewers with minimal costs and barriers to entry for the supplier as well.

The invention makes use of the fact that an increasing amount of video viewing takes place on computerized video devices that have a large amount of computing power. These video devices, exemplified by Digital Video Recorders (DVR), computers, cellular telephones, and digital video televisions often contain both storage medium (e.g. hard disks, flash memory, DVD or Blue-Ray disks, etc.), and one or more microprocessors (processors) and specialized digital video decoding processors that are used to decode the usually highly compressed digital video source information and display it on a screen in a user viewable form. These video devices are often equipped with network interfaces as well, which enables the video devices to connect with various networks such as the Internet. These video devices are also often equipped with handheld pointer devices, such as computer mice, remote controls, voice recognition, and the like, that allow the user to interact with selected portions of the computer display.

The invention acts to minimize the burden on the supplier of the item of interest or other entity desiring to annotate the video (here called the annotator) by allowing the annotator to annotate a video media with metadata and make the metadata available on a structured or unstructured P2P network in a manner that is indexed to the video media of interest, but which is not necessarily embedded in the video media of interest.

Here choice of indexing methods are important. Indexing methods based, for example, on the prior art video frame methods of Schiavi can run into copyright problems because a portion of a larger copyrighted work is often itself subject to copyright. For example, an image frame from a large Disney video that shows a copyright Disney character is itself subject to copyright restrictions under copyright law. Even the methods of Giakoumis have copyright problems, because if, for example, the 3D model was subject to copyright (e.g. a 3D model of a Disney character), even a hand drawn sketch of the Disney character would likely violate copyright.

Here, “Circular 92 Copyright Law of the United States, and Related Laws Contained in Title 17 of the United States Code December 2011” the entire contents of which are incorporated herein by reference, may be used as a convenient reference. The invention is based, in part, on the insight that it is preferable to use copyright-free indexing methods. That is, indexing methods that produce indexes that fall outside of the scope of copyright law. To do this, the general criteria that will be used herein is that the index should not be substantially similar to any unique portion of the original video. As an example, according to Circular 92 section 1309 (e): “A design shall not be deemed to have been copied from a protected design if it is original and not substantially similar in appearance to a protected design.” Put in positive language, the criteria that the index should not be substantially similar to any portion of the original video can be recast as a requirement that the index should be distinct from all portions of the original video. The index may additionally be constructed to be original as well.

There are other requirements as well. For example, in a preferred embodiment, the indexes should further not contain enough information to reproduce any unique portion of the original video, because otherwise a copyright holder could argue that the index has merely reformatted portions of the original video, rather than produced an original and not substantially similar index.

In this regard, note that it is common for videos to contain non-unique portions, such as image portions of blue sky, image portions that are pure black or white, or even portions of sound that correspond to silence of white noise. Such portions non-unique portions are generally not useful for indexing purposes because they can match many videos or many different portions of a video. At the same time, a copyright holder can hardly assert copyright privilege over such non-unique portions either. Instead, such non-unique portions are generally considered to be not copyright eligible or public domain.

Thus as a further refinement of these requirement, the first annotation index is preferably chosen to be distinct from all unique portions of the video media, and this first annotation index should preferably not contain enough information to reproduce any unique portion of this video media. The same holds true for any replica media as well. That is, generally any second user index based on replica media should also be chosen to distinct from all unique portions of the replica media, and this second user index should preferably not contain enough information to reproduce any unique portion of the replica video media either.

Thus the annotator may make the item specific metadata available directly to viewers without necessarily having to obtain either copyright permission from the owner of the video media of interest. Further, beyond the expense of creating the annotation and an appropriate index, the annotator need not be burdened with the high overhead of creating a high volume website, or pay fees to the owner of a high volume website, but may rather simply establish another node on the P2P network that holds the annotator's various indexes and metadata for various video medias that the annotator has decided to annotate.

The invention further acts to minimize the burden on the viewer (user) of a video media as well. Here the user part of the invention will often exist in the form of software located on or loaded into the viewer's particular network connected video device. This user device software will act in conjunction with the device's various processors (i.e. microprocessor(s), video processor(s)) to analyze the video medias being viewed by the viewer for characteristics (descriptors, signatures) that can serve as a useful index into the overall video media itself as well as the particular scene that a viewer may find interesting. The user software may also, in conjunction with handheld pointer device, voice recognition system, or other input device, allow a user to signify the item in a video media that the user finds to be interesting. The user software will then describe the item and use this description as another index as well. The user software will then utilize the video device's network connection and, in conjunction with a P2P network that contains the annotator's node(s), use the user index, as well as the annotator index, to select the annotator metadata that describes the item of interest and deliver this metadata to the user. This metadata may be delivered by any means possible, but in this specification, will typically be represented as an inset or window in the video display of the user's video device.

Various elaborations on this basic concept, including “push” implementations, “pull” implementations, use of structured and unstructured P2P networks, use of trusted supernodes, micropayment schemes, and other aspects will also be disclosed.

### BRIEF DESCRIPTION OF THE DRAWINGS

FIG. 1 shows an example of how an annotator of a video media may view the video media, produce a descriptor of the video media as a whole, select a specific scene and produce a descriptor of this specific scene, and finally select an item from specific portions of the video images of the specific scene of the video media, and produce an annotation item signature of this item. The annotator may additionally annotate this selected item or scene with various types of metadata.

FIG. 2 shows more details of how various portions of a video media may be selected, and annotated, and these results then stored in a database.

FIG. 3 shows an example of how a viewer of a perfect or imperfect copy (or replica) of the video media from FIG. 1 may view the replica video media, produce a descriptor of the replica video media as a whole (user media descriptor), select a specific scene and produce a descriptor of this specific scene (user scene descriptor), and finally select a user item from specific portions of the replica video images of the specific scene of the replica video media, and produce a user item signature of this user item.

FIG. 4 shows more details of how various portions of the replica video media may be selected by the user, optionally user data also created, and the various signatures and optional user data then sent over a P2P network from a second user node to a first annotation node in the form of a query.

FIG. 5 shows more details of how in a pull implementation of the invention, the various replica media user signatures and optional user data may be sent from a second user node over a P2P network to a first annotation node. The first annotation node can then compare the user replica media signatures with the annotation node's own video media, scene and item descriptor/signatures, as well as optionally compare the user data with the metadata, and if there is a suitable match, then send at least a portion of the metadata back over the P2P node to the second user node, where the metadata may then be displayed or otherwise accessed by the user.

FIG. 6 shows an alternate push embodiment of the invention. Here the annotator may have previously annotated the video as shown in FIGS. 1 and 2. However in the push version, the user may only send the replica media descriptor/signature and the optional user data across the P2P network, often at the beginning of viewing the media, or otherwise before the user has selected the specific scenes and items of interest. The scene and items descriptor/signatures may not be sent over the P2P network, but may rather continue to reside only on the user's P2P node.

FIG. 7 shows more details of the push implementation of the invention. Once the user has sent the replica media descriptor/signature and the optional user data across the P2P network, this data may in turn be picked up by one or more annotator nodes. Each annotator node can receive this user data, determine if the particular annotator node has corresponding annotation indexes for the annotator version of the user replica media, and if so send the previously computed annotation media, scene, and item descriptor/signatures and corresponding metadata back to the second user node. This annotation data can then reside on a cache in the second user node until the user selects a particular scene and/or item in the user replica media, and when this happens, appropriately matching metadata can be extracted from the cache and displayed to the user.

FIG. 8 shows how trusted P2P supernodes may act to publish white lists of acceptable/trusted annotation P2P nodes to user P2P nodes.

FIG. 9 shows how in a push implementation of the invention, various annotation P2P nodes may transfer annotation data to a P2P supernode, such as a trusted supernode. User nodes may then send queries, such as the user replica media descriptor/signature and optional user data to the P2P supernode, and the P2P supernode in turn may then transfer appropriate corresponding metadata back to the second user node. The annotation data can then be stored in a cache in the second user node until the user selects a particular scene and/or item in the user replica media, and when this happens, appropriately matching metadata can be extracted from the cache and displayed to the user.

### DETAILED DESCRIPTION OF THE INVENTION

Nomenclature: In this specification, the generic term “video devices” will be used n a broad sense. It may encompass devices such as “Digital Video Recorder” or “DVR”. Although “traditional” set top box type DVR units with hard drives, tuners, processors MPEG-2 or MPEG-4 or other video compression and decompression units, and network interfaces are encompassed by this terminology. Other video devices include computers, unitized DVR television monitor systems, video capable cell phones, DVD or Blue-Ray players, computerized pads (e.g. iPad™ or Kindle™ devices), and the like.

In one embodiment of the invention, the video devices are configured to be able to connect to one another either directly, or by intermediate use of routers, and form a peer-to-peer (P2P) network according to a predetermined protocol. Thus each video device (or node) on the P2P network can act as both a client and a server to other devices on the network.

It should be understood that as a practical matter, at least the user portions of the invention will normally be implemented in the form of software that in turn is running on video devices with network interfaces. That is, the majority of the discussion of the user portion of the specification is essentially a functional definition of the user hardware and software portion of the invention, and how it will react in various situations. Similarly the annotator portions of the invention will also normally be implemented in the form of software that is often (at least after the annotation has been done) running on annotator video devices, and annotator database systems at the annotator nodes. Thus the majority of the discussion of the annotator portion of specification is essentially also a functional definition of the annotator hardware and software portion of the invention, and how it will react in various situations.

This software for the user portion of the invention may be stored in the main program memory used to store other video device functionality, such as the device user interface, and the like, and will normally be executed on the main processor, such as a power PC processor, MIPS processor or the like that controls the main video device functionality. The user software may be able to control the functionality of the video device network interface, tuner, compression devices (i.e. MPEG-2, MPEG-4, or other compression chips or algorithms) and storage devices. Once the user authorizes or enables use of the user portion of this software, many of the P2P software algorithms and processes described in this specification may then execute on an automatic or semi-automatic basis.

The P2P network(s) useful for this invention can be implemented using a variety of physical layers and a variety of application layers. Often the P2P network(s) will be implemented as an overlay network that may overlay the same network that distributes the original digital video media among the plurality of different video devices.

In one embodiment, particularly useful for “pull” implementations of the invention, the invention may be a method of retrieving video annotation metadata stored on a plurality of annotation nodes on a P2P network. In this method, the annotator will typically select portions of at least one video media (often a video media that features the annotator's products and services in a way the annotator likes), and construct a first annotation index that describes these annotator selected portions. Usually of course, there will be a plurality of different P2P annotation nodes, often run by different organizations, but in this example, we will focus on just one annotator, one P2P annotation node, and one specific item of interest.

For example, a car manufacturer might select a video media that features the manufacturer's car, find scenes where the car looks particularly good, and select these scenes. The manufacturer might also optionally specify the dimensions of a bounding box that locates the position of the car on the screen (video image), or specify certain image features of the car that are robust and likely to be reproducible, and use these image features to further describe the specific location of the car in the video image. This is the first annotation index.

The annotator may then annotate this first annotation index with annotation metadata (e.g. additional information about the car), and make this first annotation index available for search on at least one node (first annotation node) of the P2P network.

For example, a car manufacturer might annotate the “car” index with metadata information such as the model of the car, price of the car, location where the car might be seen or purchased, financing terms, and so on.

On the viewer (user) side, the user in turn will also view the video media. This need not be a perfect or identical copy of the same video media used by the annotator. Often the video media viewed by the user will be an imperfect replica of the video media originally annotated by the annotator. The resolution of the replica video media may be different from the original video media (i.e. the original video media may have been in High definition at a first frame rate, such as 1080p at 60 frames per second, and the replica video media may be in 576p at 25 frames per second or some other differing resolution and frame rate. Additionally the original video media may have been edited, and the replica video media may either have some scenes from the original video media deleted, or alternatively additional (new) scenes inserted. For this reason, the video media being viewed by the user will be termed a replica video media.

The user will view a perfect or imperfect replica of the video media, and in the course of viewing the replica media may come across an item of interest, such as the same car previously annotated by the car manufacturer. The user will inform his or her video device by selecting at least one portion of interest to the user. This will often be done by a handheld pointing device such as a mouse or remote control, by touch screen, by voice command such as “show me the car”, or other means.

When the user indicates interest by selecting a portion of the replica video media, invention's software running on the user's video device will analyze the replica video media. In particular, the processor(s) on the video device will often construct a second user index that describes the video media and at least the portion of the video media that the user is interested in.

The software running on the user's video device will then often send this second user index across the P2P network. This may be done in the form of a search query or other query from the user's video device, which often may be regarded as a second user node on the P2P network.

Because, in the preferred embodiment, the first annotation index is chosen to be distinct from all unique portions of said at least one video media, generally the second user index may also be chosen to be distinct from all unique portions of the video media running on the user's video device as well. To facilitate index matching, in another preferred embodiment, the second user index may also be chosen to match as closely as possible with the first annotation index.

The second user index may also be chosen to be “original” at least with respect to the video media. However the second user index need not be either “original” or distinct with respect to the first annotation index, and indeed may often be similar and not original with respect to the first annotation index. This is because in order to use the system, the consent of the annotator to make copies of the annotation indexes can be implicitly assumed, or alternatively be made part of the terms of use for the system.

In one embodiment, this second user query may be eventually received (either directly or indirectly) at the first annotation node on the P2P network. There the first annotation node may compare the received second user index with the previously prepared first annotation index, and determine if the match is adequate. Here a perfect match may not always be possible, because due to differences between the replica video media and the original video media, as well as user reaction time differences in selecting scenes and items within a scene, there will likely be differences. Thus the matching criteria will often be selected as to balance the ratio between false positive matches and false negative matches in a manner that the annotator views as being favorable.

In this “pull” embodiment, when the comparison between the second user index and the first annotation index is adequate, the first annotation node will often then retrieve at least a part of the annotation metadata previously associated with the first annotation index and send this back to the second user node, usually using the same P2P network. Alternatively, at least some of this annotation metadata can be sent to the user by other means, such as by direct physical mailing, email, posting to an internet account previously designated by the user, and so on. However even here, often the first annotation index will at least send some form of confirmation data or metadata back to the second user node confirming that the user has successfully found a match to the user expression of interest or query, and that further information is going to be made available.

Many other embodiments of the invention are also possible. In a second type of “push” embodiment most of the basic aspects of the invention are the same, however the data flow across the P2P network can be somewhat different, because annotator data may be sent to the user before the user actually selects a scene or item of interest.

In this push embodiment method, as before, the annotator can again select portions of at least one video media, and again construct at least a first annotation index that describes the various annotator selected portions. The annotator will again also at least a first annotation index with annotation metadata, and again make at least portions of this first annotation index available for download from the annotators first annotation node on the P2P network.

As before, again a user will view a perfect or imperfect replica of this video media, and this will again be called a replica media. Invention software, often running on the user's video device, will then (often automatically) construct a user media selection that identifies this replica video media. Here the identification could be as simple as the title of the replica video media, or as complex as an automated analysis of the contents of the replica video media, and generation of a signature or hash function of the replica video media that will ideally be robust with respect to changes in video media resolution and editing differences between the replica video media and the original video media.

The user identification protocols should ideally be similar to the identification protocols used by the annotator. Note that there is no requirement that only one type of identification protocol be used. That is both the annotator and the user can construct a variety of different indexes using a variety of different protocols, and as long as there is at least one match in common, the system and method will function adequately.

The user media selection (which may not contain specific user selected scenes and items), along with optional user data (such as user location (e.g. zip code), user interests, buying habits, income, social networks or affiliation, and whatever else the user cares to disclose) can then be sent across the P2P network as a “push invitation” query or message from the second user node on the P2P network.

Note one important difference between the “push” embodiment, and the “pull” embodiment described previously. In the “push” embodiment, the user has not necessarily selected the scene and item of interest before the user's video device sends a query. Rather, the invention software, often running on one or more processors in the user's video device, may do this process automatically either at the time that the user selects the replica video media of being of potential viewing interest, at the time the user commences viewing the replica video media, or during viewing of the video media as well. The user's video device may also make this request on a retrospective basis after the user has finished viewing the replica video media.

This user video media selection query can then be received at the first annotation node (or alternatively at a trusted supernode, to be discussed later) on the P2P network. Indeed this first user query can in fact be received at a plurality of such first annotation nodes which may in turn be controlled by a variety of organizations, but here for simplicity we will again focus on just one first annotation node.

At the first annotation node, the received user media selection will be compared with at least a first annotation index, and if the user media selection and at least the first annotation index adequately match, the first annotation node retrieving at least this first annotation index will send at least some this first annotation index (and optional associated annotation metadata) back to the second user node, usually using the P2P network.

Note that the user has still not selected the scene of interest or item of interest in the user's replica video media. However information that can now link scenes of interest and items of interest, along with optional associated metadata, is now available in a data cache or other memory storage at the second user P2P node, and thus available to the user's video device, often before the user has made the selection of scene and optional item of interest. Thus the response time for this alternate push embodiment can often be quite fast, at least from the user perspective.

As before, the user can then watch the replica video media and select at least one portion of user interest in this replica media. Once this user selection has been made, the software running on the user's video device can then construct at least a second user index that describes this selected portion.

Note, however that in at least some push embodiments, the comparison of the second user index with the first annotation index now may take place local to the user. This is because the annotation data was “pushed” from the first annotation node to the second user node prior to the user selection of a scene or item of interest. Thus when the selection is made, the annotation data is immediately available because it is residing in a cache in the second user node or user video device. Thus the response time may be faster.

After this step, the end results in terms of presenting information to the user are much the same as in the pull embodiment. That is, if the second user index and the first annotation index adequately match, at least some of the first annotation metadata can now be displayed by the said second user node, or a user video device attached to the second user node. Alternatively at least some of the first annotation metadata may be conveyed to the user by various alternate means as previously described.

### Constructing First Annotation Indexes and Second User Indexes

Generally, in order to facilitate comparisons between the first annotation indexes and the second user indexes, similar methods (e.g. computerized video recognition algorithms) will be used by both the annotator and user. Multiple different video indexing methods may be used. Ideally these methods will be chosen to be relatively robust to differences between the original video content and the replica video content.

The video indexing methods will tend to differ in the amount of computational ability required by the second user node or user video device. In the case when the user video device or second user node has relatively limited excess computational ability, the video index methods can be as simple as comparing video media names (for example the title of the video media, or titles derived from secondary sources such as video media metadata, Electronic Program Guides (EPG), Interactive Program Guides (IPG), and the like).

The location of the scenes of interest to the annotator and user can also be specified by computationally non-demanding methods. For scene selection, this can be as simple as the number of minutes and seconds since the beginning of the video media playback, or until the end of the video, or other video media program milestone. Alternatively the scenes can be selected by video frame count, scene number, or other simple indexing system.

The location of the items of interest to the annotator and user can additionally be specified by computationally non-demanding methods. These methods can include use of bounding boxes (or bounding masks, or other shapes) to indicate approximately where in the video frames in the scenes of interest, the item of interest resides.

Since the annotator normally will desire to have the media annotations accessible to as broad an audience as possible, in many embodiments of the invention, one indexing methodology will be the simple and computationally “easy” methods described above.

One drawback of these simple and computationally undemanding methods, however, is that they may not always be optimally robust. For example, the same video media may be given different names. Another problem is that, as previously discussed, the original and replica video media may be edited differently, and this can throw off frame count or timing index methods. The original and replica video media may also be cropped differently, and this may throw off bounding box methods. The resolutions and frame rates may also differ. Thus in a preferred embodiment of the invention, both the annotator and the user's video device will construct alternate and more robust indexes based upon aspects and features of the video material that will usually tend to be preserved between original and replica video medias. Often these methods will use automated image and video recognition methods (as well as optionally sound recognition methods) that attempt to scan the video and replica video material for key features and sequences of features that tend to be preserved between original and replica video sources.

### Automated Video Analysis

Many methods of automated video analysis have been proposed in the literature, and many of these methods are suitable for the invention's automated indexing methods. Although certain automated video analysis methods will be incorporated herein by reference and thus rather completely described, these particular examples are not intended to be limiting.

Exemplary methods for automated video analysis include the feature based analysis methods of Rakib et. al., U.S. patent application Ser. No. 12/350,883 (publication 2010/0008643) “Methods and systems for interacting with viewers of video content”, published Jan. 14, 2010, Bronstein et. al., U.S. patent application Ser. No. 12/350,889 (publication 2010/0011392), published Jan. 14, 2010; Rakib et. al., U.S. patent application Ser. No. 12/350,869 (publication 2010/0005488) “Contextual advertising”, published Jan. 7, 2010; Bronstein et. al., U.S. patent application Ser. No. 12/349,473 (publication 2009/0259633), “Universal lookup of video related data”, published Oct. 15, 2009; Rakib et. al., U.S. patent application Ser. No. 12/423,752 (publication 2009/0327894), “Systems and Methods for Remote Control of Interactive Video”, published Dec. 31, 2009; Bronstein et. al., U.S. patent application Ser. No. 12/349,478 (publication 2009/0175538) “Methods and systems for representation and matching of video content”, published Jul. 9, 2009; and Bronstein et. al., U.S. patent application Ser. No. 12/174,558 (publication 2009/0022472), “Method and apparatus for video digest generation”, published Jan. 22, 2009. The contents of these applications (e.g. Ser. Nos. 12/350,883; 12/350,889; 12/350,869; 12/349,473; 12/423,752; 12/349,478; and 12/174,558) are incorporated herein by reference.

Methods to select objects of interest in a video display include Kimmel et. al., U.S. patent application Ser. No. 12/107,008 (2009/0262075), published Oct. 22, 2009. The contents of this application are also incorporated herein by reference.

In this context, the contents of parent applications 61/045,278 “VIDEO GENOMICS: A FRAMEWORK FOR REPRESENTATION AND MATCHING OF VIDEO CONTENT” filed Apr. 15, 2008, parent application Ser. No. 14/269,333 filed May 5, 2014 (which was a continuation of parent application Ser. No. 12/349,473, “Universal Lookup of Video-Related Data” filed Jan. 6, 2009), and parent application Ser. No. 12/423,752, “Systems and methods for remote control of interactive video”, filed Apr. 14, 2009 are particularly relevant, and the entire contents of 61/045,278, Ser. Nos. 14/269,333, 12/349,473 and 12/423,752 are also included herein by reference. This work is relevant because it produces indexes that are both original with respect to the video being analyzed, and because the indexes also distinct from all portions of the video media. Thus this type of index will generally be free from copyright issues with respect to the owners of the video media.

Generally, these methods operate by using computerized image analysis (e.g. artificial image recognition methods) to identify image features in the video being analyzed, and constructing an index based on the spatial and temporal coordinates of these various features. The image features can be points that are easily detectable in the video image frames in a way that is preferably invariant or at least robust to various image and video modifications. The feature can include both the coordinates of the point of interest, as well as a descriptor that describes the environment around the point of interest. Features can be chosen for their ability to persist even if an image is rotated, presented with altered resolution, presented with different lighting, and so on.

Examples of features include the Harris corner detector and its variants, as described in C. Harris and M. Stephens, “A combined corner and edge detector”, Proceedings of the 4th Alvey Vision Conference, 1988; Scale invariant feature transform (SIFT), described in D. G. Lowe, “Distinctive image features from scale-invariant keypoints,” International Journal of Computer Vision, 2004; Motion vectors obtained by decoding the video stream; Direction of spatial-temporal edges; Distribution of color; Description of texture; Coefficients of decomposition of the pixels in some known dictionary, e.g., of wavelets, curvelets, etc. and the like.

In some embodiments, these points of interest can be automatically tracked over multiple video frames to prune insignificant or temporally inconsistent (e.g. appearing for too short of a time period) points. In some embodiments, the remaining points can then be described using a local feature descriptor, e.g., SIFT based on a local distribution of gradient directions; or Speed up robust features (SURF) algorithm, described in H. Bay, T. Tuytelaars and L. van Gool, “Speed up robust features”, 2006, where the descriptor is represented as a vector of values.

For either and all methods of video analysis, often the analysis will produce an “address” of a particular object of interest in a hierarchical manner from most general to most specific, not unlike addressing a letter. That is, the top most level of the hierarchy might be an overall program descriptor/signature of the video media as a whole, a lower level would be a scene descriptor/signature, and a still lower level would be the item descriptor/signature. Although this three level hierarchy will be often used in many of the specific examples and figures in this application, other methods are also possible. For example, for some applications, simply the item descriptor alone may be sufficient to uniquely identify the item of interest, in which case either or both of the annotation index and the user index may simply consist of the item descriptor/signature, and it is only the item descriptor/signature that is sent over the P2P network. In other applications, simply the scene descriptor along may be sufficient, and this case either or both of the annotation index and the user index will simply consist of the scene descriptor/signature. In some applications, simply the descriptor/signature of the video media as a whole may be sufficient, and it is only the descriptor/signature of the video media as a whole that is transmitted over the internet. Alternatively any and all permutations of these levels may be used. For example, a descriptor/signature of the video media as a whole plus the item descriptor/signature may be sent over the P2P network without the scene descriptor/signature. As another example, the descriptor/signature of the video media as a whole plus the scene descriptor/signature may be sent over the P2P network without the item descriptor/signature. As yet another example, the scene descriptor/signature plus the item descriptor/signature may be sent over the P2P network without the descriptor signature of the video media as a whole. As a fourth example, additional hierarchical levels may be defined that fall intermediate between the descriptor/levels of the video media as a whole, the scene descriptor/signature, and the item descriptor/signature, and descriptor signatures of these additional hierarchal levels may also be sent over the P2P network in addition to, or as a substitution to, these previously defined levels.

### EXAMPLES

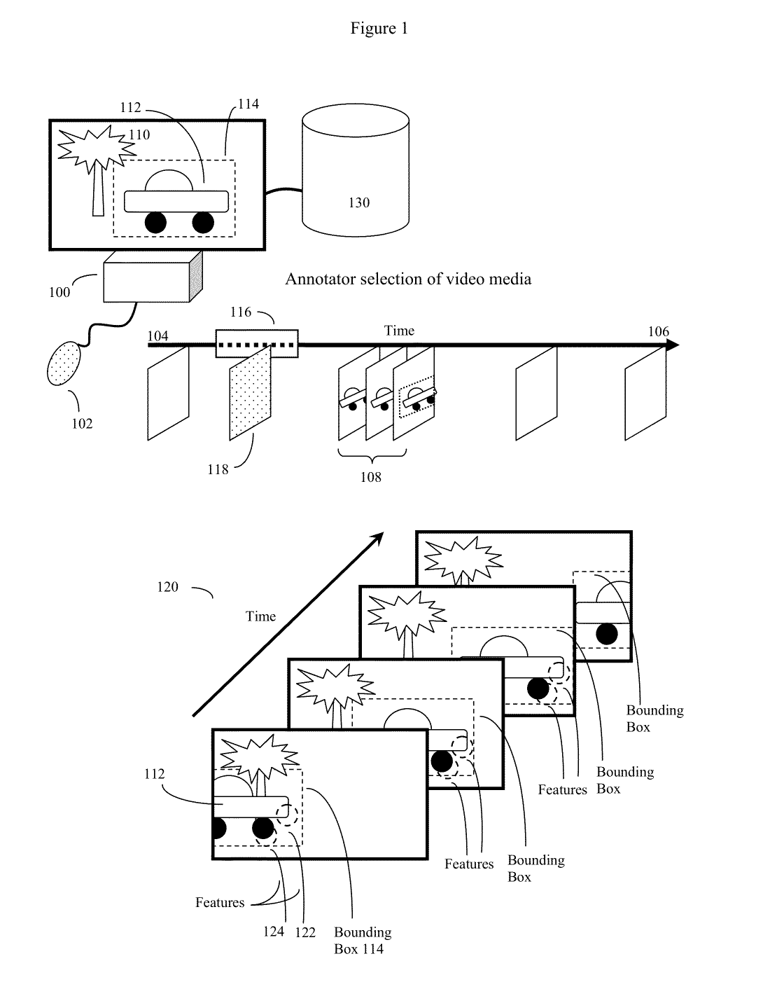

FIG. 1 shows an example of how an annotator of a video media may view the video media, produce a descriptor of the video media as a whole, select a specific scene and produce a descriptor of this specific scene, and finally select an item from specific portions of the video images of the specific scene of the video media, and produce an annotation item signature of this item. The annotator may additionally annotate this selected item or scene with various types of metadata.

Here the annotator (not shown) may play a video media on an annotator video device (100) and use a pointing device such as a mouse (102) or other device to select scenes and portions of interest in the video media. These scenes and portions of interest are shown in context in a series of video frames from the media as a whole, where (104) represents the beginning of the video media, (106) represents that end of the video media, and (108) represents a number of video frames from a scene of interest to the annotator. One of these frames is shown magnified in the video display of the annotator video device (110). The annotator has indicated interest in one item, here a car (112), and a bounding box encompassing the car is shown as (114).

A portion of the video media that will end up being edited out of the replica video media is shown as (116), and a video frame from this later to be edited portion is shown as (118).

Some of the steps in an optional automated video indexing process performed by the annotator are shown in (120). Here video frames from scene (108) are shown magnified in more detail. As can be seen, the car (112) is moving into and out of the scene. Here, one way to automatically index the car item in the video scene is to use a mathematical algorithm or image processing chip that can pick out key visual features in the car (here the front bumper (122) and a portion of the front tire (124) and track these features as the car enters and exits the scene of interest. Here the term “features” may include such features as previously described by application Ser. Nos. 12/350,883; 12/350,889; 12/350,869; 12/349,473; 12/423,752; 12/349,478; 12/174,558; 12/107,008 and 11/944,290; the contents of which are incorporated herein by reference. Often these features may be accumulated over multiple video frames (e.g. integrated over time) to form a temporal signature as well as a spatial signature, again as previously described by application Ser. Nos. 12/350,883; 12/350,889; 12/350,869; 12/349,473; 12/423,752; 12/349,478; 12/174,558; 12/107,008 and 11/944,290; the contents of which are incorporated herein by reference.

Often for example, signatures of multiple frames or multiple features may be combined to produce still more complex signatures. These more complex signatures may in turn be combined into a still higher order signature that often will contain many sub-signatures from various time portions of the various video frames. Although some specific examples of such a complex higher order video signature are the Video DNA methods described in Ser. Nos. 12/350,883; 12/350,889; 12/350,869; 12/349,473; 12/423,752; 12/349,478; 12/174,558; and 12/107,008 as well as the methods of Ser. No. 11/944,290; the contents of all of these applications incorporated herein by reference; many other alternative signature generating methods may also be used.

By accumulating enough features, and constructing signatures based on these features, particular items can be identified in a robust manner that will persist even if the replica video media has a different resolution or frame count, noise, or is edited. Similarly, by accumulating enough features on other visual elements in the scene (not shown) a signature of the various video frames in the scene of interest can also be constructed. Indeed, a signature of the entire video media may be produced by these methods, and this signature may be selected to be relatively robust to editing and other differences between the original video media and the replica video media. This data may be stored in an annotator database (130).

To generalize, these methods can produce first annotation indexes by using artificial image recognition methods that automatically identify object features in video images in the video media, and use these object features to produce annotation indexes. The methods can also produce second user indexes in a similar manner, buy using artificial image recognition methods that automatically identify replica object features in video images in the replica media, and use these replica object features to produce various second user indexes as well.

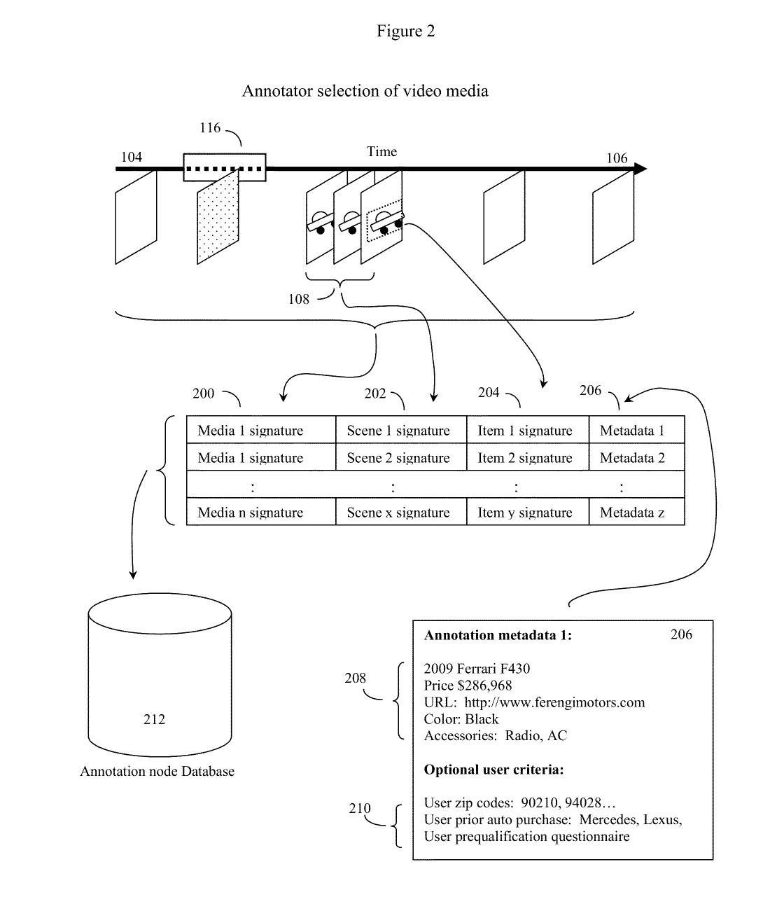

FIG. 2 shows more details of how various portions of a video media may be selected, and annotated, and these results then stored in a database. One data field may be a descriptor (such as the video media name) or signature (such as an automated image analysis or signature of the video media as a whole). Typically each different video media will have its own unique media descriptor or signature (200). Similarly selected scenes from the video media can each have their own unique scene descriptor or signature (202). Similarly individual items in scenes of interest can have their own item descriptor or signature, which will often be a bounding box or mask, a video feature signature, or other unique signature/descriptor (204).

The annotator will often annotate the video media index with annotation metadata (206). This annotation metadata can contain data intended to show to the user, such as information pertaining to the name of the item, price of the item, location of the item, and so on (208). The annotation metadata can optionally also contain additional data (optional user criteria) that may not be intended for user viewing, but rather is used to determine if any given user is an appropriate match for the metadata. Thus for example, if the user is located in a typically low income Zip code, the optional user criteria (210) may be used to block the Ferrari information.

This annotation indexing information and associated annotation data may be compiled from many different video medias, scenes, items of interest, annotation metadata, and optional user criteria, and stored in a database (212) which may be the same database previously used (130), or an alternate database.

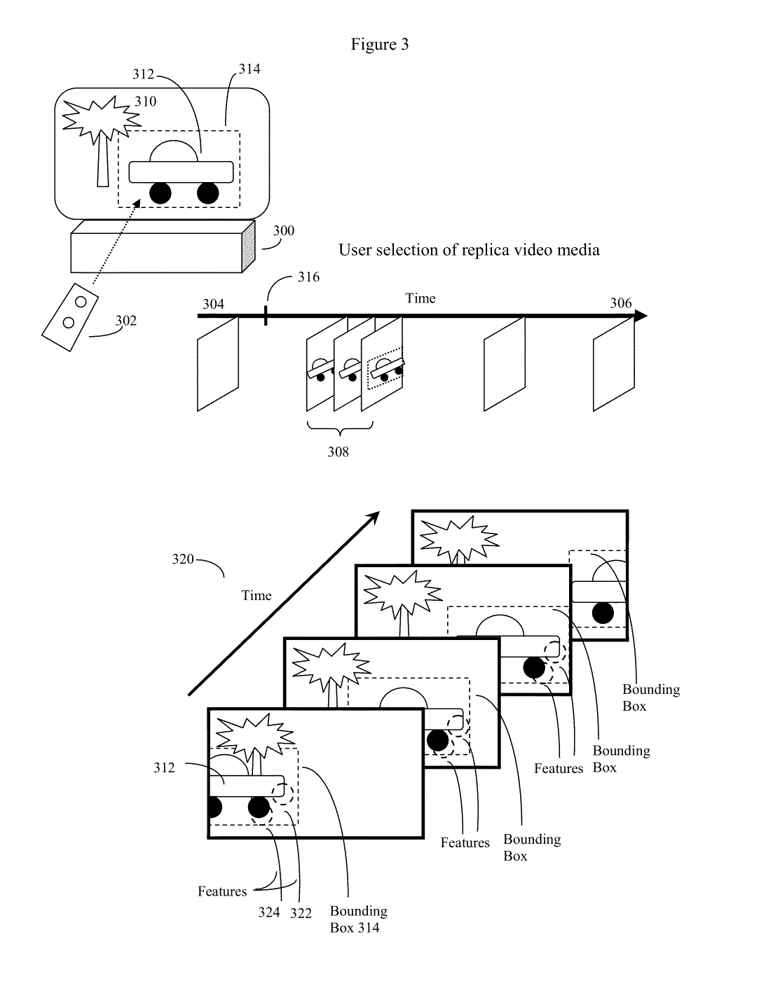

FIG. 3 shows an example of how a viewer of a perfect or imperfect copy (or replica) of the video media from FIG. 1 may view the replica video media, produce a descriptor of the replica video media as a whole (user media descriptor), select a specific scene and produce a descriptor of this specific scene (user scene descriptor), and finally select a user item from specific portions of the replica video images of the specific scene of the replica video media, and produce a user item signature of this user item.

Here the viewer (not shown) may play a replica video media on a user video device (300) and use a pointing device such as remote control (302), voice command, touch screen, or other device to select scenes and portions of interest in the video media. These scenes and portions of interest are also shown in context in a series of video frames from the replica video media as a whole, where (304) represents the beginning of the video media, (306) represents that end of the video media, and (308) represents a number of video frames from the scene of interest to the viewer. One of these frames is shown magnified in the video display of the viewer video device (310). The viewer has indicated interest in one item, again a replica image of a car (312), and a bounding box encompassing the car is shown as (314).

In this replica video media, the portion (116) of the original video media that ended up being edited out of the replica video media is shown as edit mark (316), and the video frame (118) from edited portion is of course absent from the replica video media.

Some of the steps in an automated user video indexing process performed by the user video device are shown in (320). Here video frames from scene (308) are shown magnified in more detail. As before, the replica image of the car (312) is moving into and out of the scene. Here, one way to automatically index the car item in the replica video scene is to again to use a mathematical algorithm or image processing chip that can pick out key visual features in the replica image of the car (here the front bumper (322) and a portion of the front tire (324) and track these features as the car enters and exits the scene of interest. By accumulating enough features, and constructing signatures based on these signatures, particular items again can be identified in a robust manner that will be similar enough that they can be identified in both the replica video media and the original video media.

Similarly, by accumulating enough features on other visual elements in the scene (not shown) a signature of the various replica video frames in the scene of interest can again also be constructed. Indeed, a signature of the entire replica video media may be produced by these methods, and this signature may be selected to be relatively robust to editing and other differences between the original video media and the replica video media.

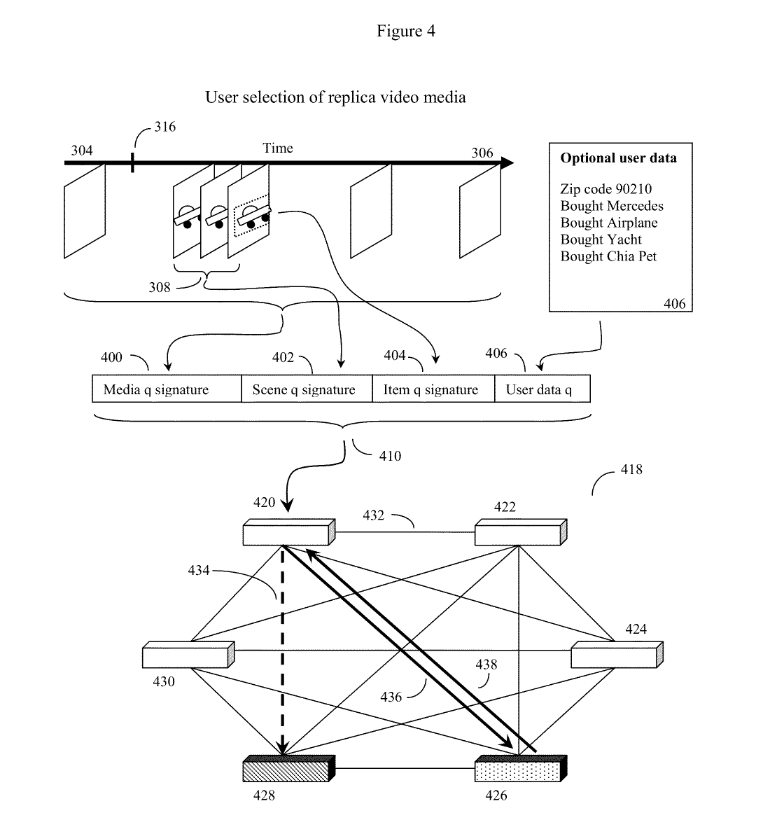

FIG. 4 shows more details of how various portions of the replica video media may be selected by the user, optional user data also created, and the various signatures and optional user data then sent over a P2P network (418) from a second user node to a first annotation node in the form of a query.

In a manner very similar to the annotation process previously described in FIG. 2, here one user data field may be a descriptor (such as the replica video media name) or signature (such as an automated image analysis or signature of the replica video media as a whole). Typically each different replica video media will have its own unique media descriptor or signature (400). Similarly user selected scenes from the replica video media can each have their own unique scene descriptor or signature (402). Similarly individual items in replica video scenes of interest to the user can also have their own item descriptor or signature, which will often be a bounding box or mask, a video feature signature, or other unique signature/descriptor (404).

In order to help insure that the user only receives relevant metadata from various annotation sources, user may often to choose to make optional user data (406) available to various P2P annotation sources as well. This optional user data (406) can contain items such as the user zip code, purchasing habits, and other data that the user decides is suitable for public disclosure. This optional user data will often be entered in by the user into the video device using a user interface on the video device, and will ideally (for privacy reasons) be subject to editing and other forms of user control. A user wishing more relevant annotation will tend to disclose more optional user data, while a user desiring more privacy will tend to disclose less optional user data. Users may also turn the video annotation capability on and off as they so choose.

In this “pull” embodiment, as the user watches the replica video media and selects scenes and items of interest, the descriptors or signatures for the replica video media, scenes of user interest, items of user interest, and the optional user data can be transmitted over a P2P network in the form of queries to other P2P devices. Here the user video device can be considered to be a node (second user node) in the P2P network (420). Many different user video devices can, of course co-exist on the P2P network, often as different user nodes, but here we will focus on just one user video device and one user node.

In one embodiment, the P2P network (418) can be an overlay network on top of the Internet, and the various P2P network nodes (420), (422), (424), (426), (428), (430), can communicate directly using standard Internet P2P protocols (432), such as the previously discussed Gnutella protocols.

In FIG. 4, the user video device or node (420) has sent out queries or messages (434), (436) to annotator nodes (428) and (426). In this example, annotator node (428) may not have any records corresponding to the particular replica video media that the user is viewing (400), or alternatively the optional user data (406) may not be a good match for the optional user criteria (210) in the annotation metadata (206), and thus here annotator node (428) is either not responding or alternatively is sending back a simple response such as a “no data” response. These operations will, of course, normally be done using software that controls processors on the various devices, and directs the processors and devices to perform these functions.

However, in this example, a different annotator node (426) does have a record corresponding to the particular replica video media that the user is viewing (400), and here also assume that the scene signature field (402) and item signature field (404) and optional user data field (406) match up properly with the annotator's media signature fields (200), the scene signature field (202), the item signature field (204) and the optional user criteria field (210). In this case, annotation node (426) will respond with a P2P message or data (438) that conveys the proper annotation metadata (208) back to user video device node (420).

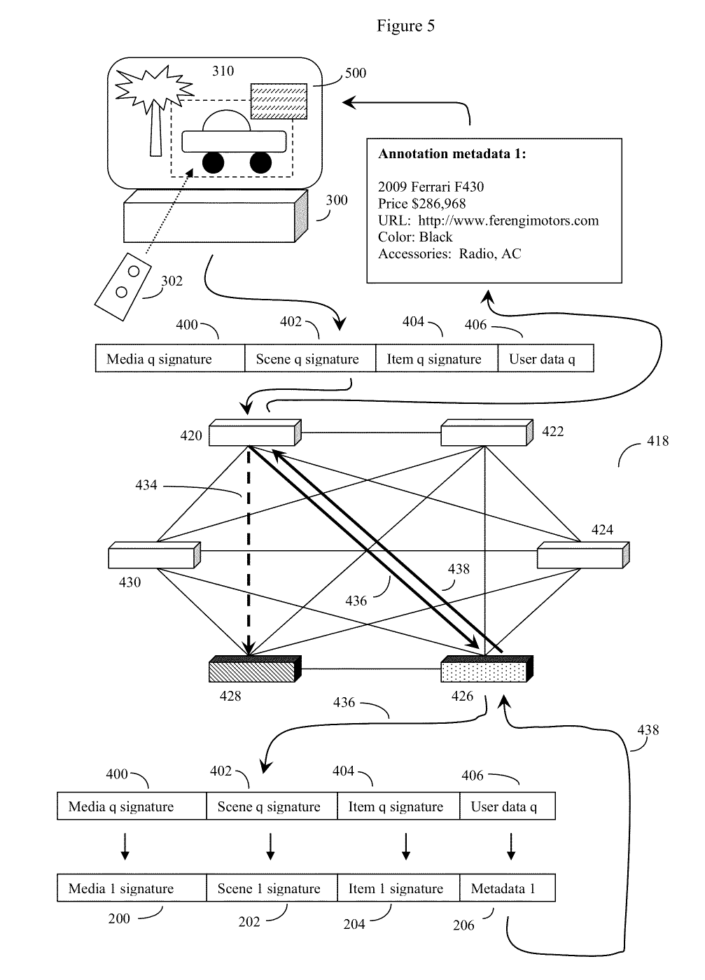

FIG. 5 shows more details of how in a pull implementation of the invention, the various replica media user signatures and optional user data (400, 402, 404, and 406) may be sent from a second user node (420) over a P2P network to a first annotation node (426). The first annotation node can then compare the user replica media signatures (400, 402, 404) with the annotation node's own video media, scene and item descriptor/signatures (200, 202, 204), as well as optionally compare the user data (406) with the metadata, (206) and if there is a suitable match (i.e. if the user data (406) and the optional user criteria (210) match), then send at least a portion of the metadata (208) back over the P2P node to the second user node (420), where the metadata (208) may then be displayed or otherwise accessed by the user. In this example, the user viewable portion of the metadata (208) is being displayed in an inset (500) in the user's video device display screen (310).

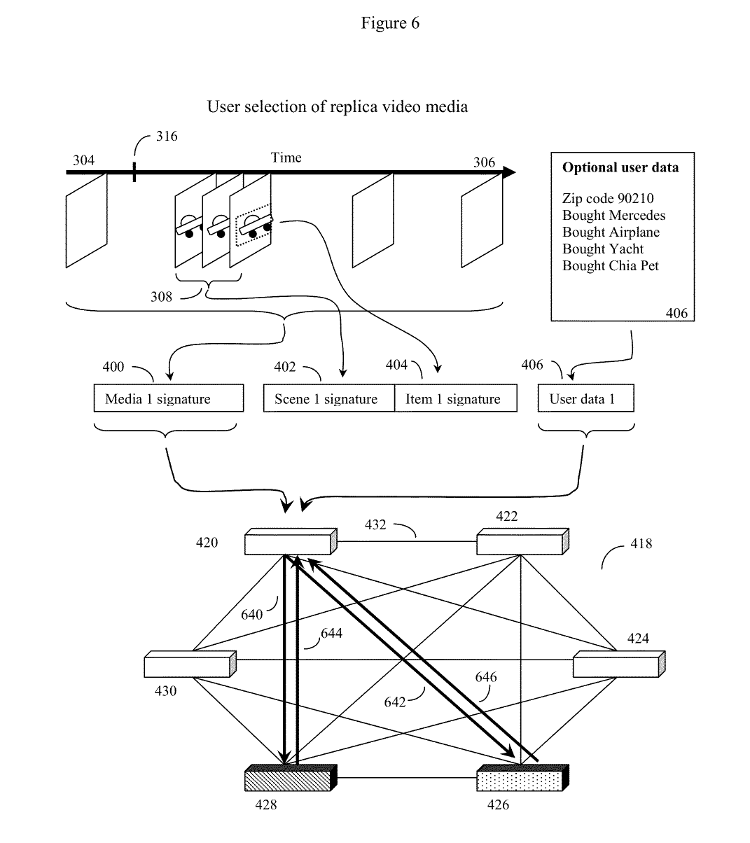

FIG. 6 shows an alternate push embodiment of the invention. Here the annotator again may have previously annotated the video as shown in FIGS. 1 and 2. However in the push version, the user may only send the replica media descriptor/signature (400) and the optional user data (406) across the P2P network, often at the beginning of viewing the media, or otherwise before the user has selected the specific scenes and items of interest. The user scene and user items descriptor/signatures (402), (404) may not be sent over the P2P network, but may rather continue to reside only on the user's P2P node (420).

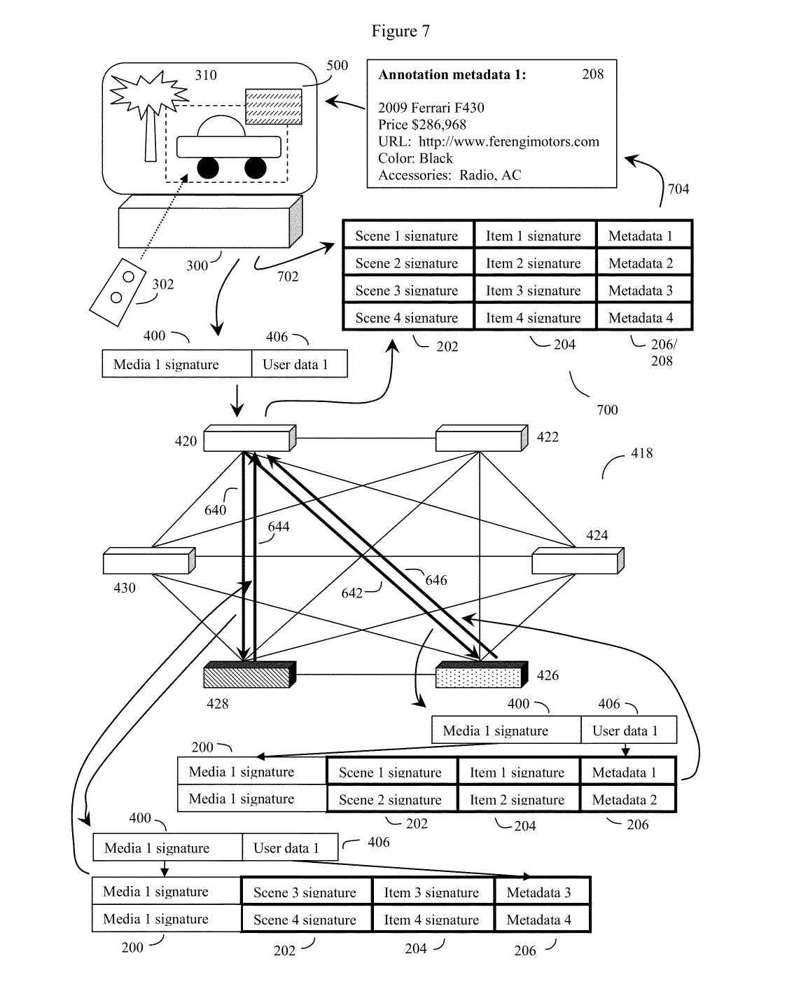

In this push embodiment, the second user node (420) is making contact with both annotation node (428) and annotation node (426). Here assume that both annotation nodes (428) and (426) have stored data corresponding to media signature (400) and that the optional user data (406) properly matches any optional user criteria (210) as well. Thus in this case, second user node (420) sends a first push invitation query (640) containing elements (400) and (406) from second user node (420) to annotator node (428), and a second push invitation query (642) containing the same elements (400), and (406) to annotator node (426). These nodes respond back with push messages (644) and (646), which will be discussed in FIG. 7.

FIG. 7 shows more details of how in a push implementation of the invention, once the user has sent (640), (642) the replica media descriptor/signature (400) and the optional user data (406) across the P2P network (418), this data may in turn be picked up by one or more annotator nodes (426), (428). Each node can receive this user data (400), (406), determine if the particular node has corresponding annotation indexes for the annotator version of the user replica media (200), and if so send (644), (646) the previously computed annotation media descriptor/signatures (not shown), scene descriptor/signatures (202), item descriptor/signatures (204) and corresponding metadata (206/208) back to the second user node (420) (which in turn is usually either part of, or is connected to, user video device (300)). This annotation data (200), (202), (204), (206) can then reside on a cache (700) in the second user node (420) and/or user video device (300) until the user selects (302) a particular scene and/or item in the user replica media.

When this happens, appropriate replica video scene and item descriptor/signatures can be generated at the user video device (300) according to the previously discussed methods. These descriptors/signatures can then be used to look up (702) the appropriate match in the cache (700), and the metadata (206/208) that corresponds to this match can then be extracted (704) from the cache (700) and displayed to the user (208), (500) as previously discussed.

Note that in this push version, since the metadata is stored in the cache (700) in user video device (300), the metadata can be almost instantly retrieved when the user requests the information.

Although using P2P networks has a big advantage in terms of flexibility and low costs of operation for both annotators and viewers, one drawback is “spam”. In other words, marginal or even fraudulent annotators could send unwanted or misleading information to users. As a result, in some embodiments of the invention, use of additional methods to insure quality, such as trusted supernodes, will be advantageous.

Trusted supernodes can act to insure quality by, for example, publishing white lists of trusted annotation nodes, or conversely by publishing blacklists of non-trusted annotation nodes. Since new annotation nodes can be quickly added to the P2P network, often use of the white list approach will be advantageous.

As another or alternative step to insure quality, the trusted supernode may additionally impose various types of payments or micro-payments, usually on the various annotation nodes. For example, consider hotels that may wish to be found when a user clicks a video scene showing a scenic location. A large number of hotels may be interested in annotating the video so that the user can find information pertaining to each different hotel. Here some sort of priority ranking system is essential, because otherwise the user's video screen, email, social network page or other means of receiving the hotel metadata will be overly cluttered with too many responses. To help resolve this type of problem, the trusted supernode, in addition to publishing a white list that validates that all the different hotel annotation nodes are legitimate, may additionally impose a “per-click” or other use fee that may, for example, be established by competitive bidding. Alternatively, the different P2P nodes may themselves “vote” on the quality of various sites, and send their votes to the trusted supernode(s). The trusted supernode(s) may then rank these votes, and assign priority based upon votes, user fees, or some combination of votes and user fees.

As a result, trusted supernodes can both help prevent “spam” and fraud, and also help regulate the flow of information to users to insure that the highest priority or highest value information gets to the user first.

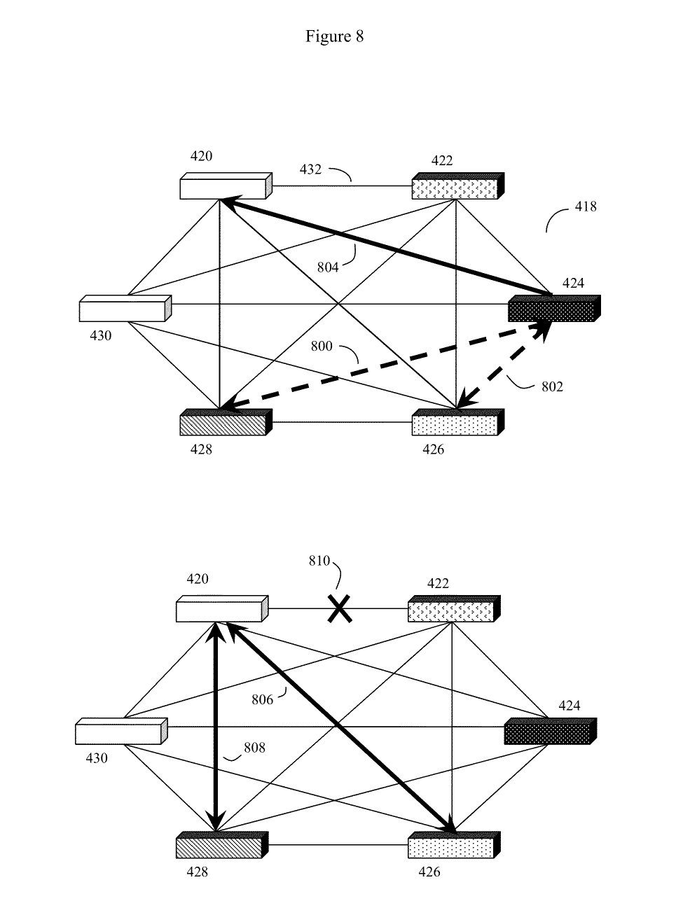

FIG. 8 shows how trusted P2P supernodes may act to publish white lists of acceptable/trusted annotation P2P nodes to user P2P nodes. Here node (424) is a trusted supernode. Trusted supernode (424) has communicated with annotation nodes (428) and (426) by message transfer (800) and (802) or other method, and has established that these notes are legitimate. As a result, trusted supernode (424) sends user node (420) a message (804) containing a white list showing that annotation nodes (428) and (426) are legitimate. By contrast, annotation node (422) either has not been verified by trusted supernode (424), or alternatively has proven to be not legitimate, and as a result, annotation node (422) does not appear on the white list published by trusted supernode (424). Thus user node (420) will communicate (806), (808) with annotation nodes (428) and (426) but will not attempt to communicate (810) with non-verified node (422).

Often, it may be useful for a manufacturer of a video device designed to function according to the invention to provide the video device software with an initial set of trusted supernodes and/or white lists in order to allow a newly installed video device to connect up to the P2P network and establish high quality links in an efficient manner.

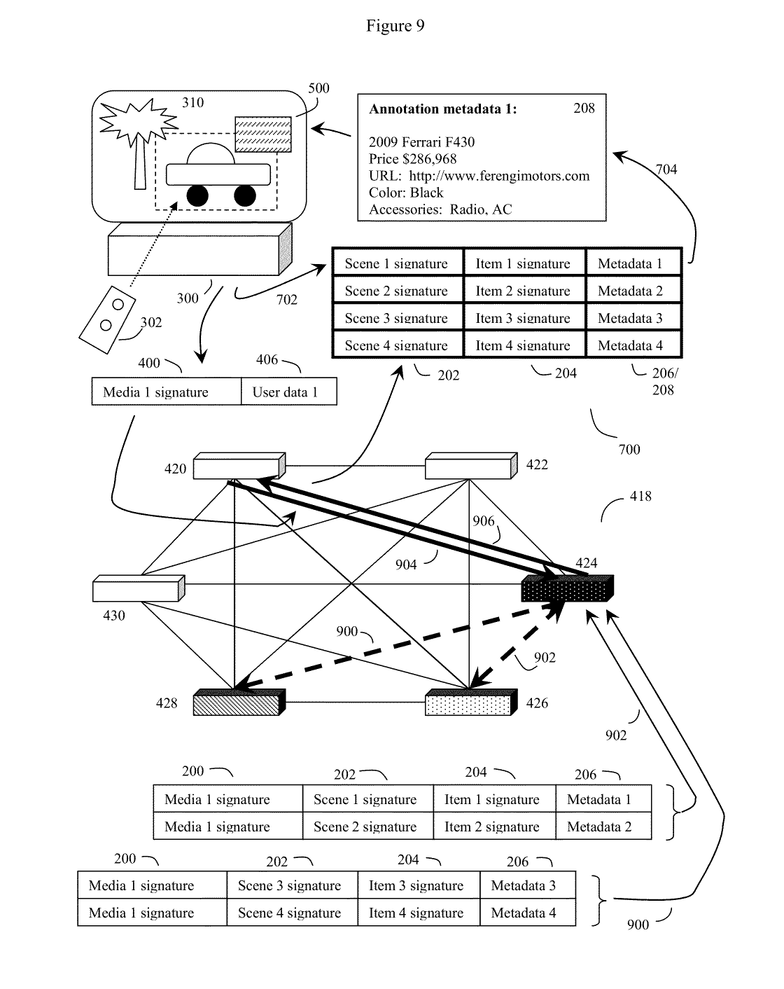

In addition to helping to establish trust and regulating responses by priority, supernodes can also act to consolidate annotation data from a variety of different annotation nodes. Such consolidation supernodes, which often may be trusted supernodes as well, can function using either the push or pull models discussed previously. In FIG. 9, a trusted annotation consolidation supernode is shown operating in the push mode.

FIG. 9 shows how in a push implementation of the invention, various annotation P2P nodes (426), (428) may optionally transfer annotation data (900), (902) to a consolidation supernode (424), here assumed to also be a trusted supernode. User nodes (420) may then send “push request” queries (904), such as the user replica media descriptor/signature (400) and optional user data (406) to the P2P supernode (424), and the P2P supernode (424) in turn may then transfer appropriate corresponding metadata consolidated from many different annotation nodes (426), (428) back (906) to the second user node (420). The annotation data can again then be stored in a cache (700) in the second user node (420) or video device (300) until the user selects a particular scene (302) and/or item in the user replica media, and when this happens, appropriately matching metadata (208) can again be extracted from the cache and displayed to the user (500) as described previously.

The advantages of such consolidation supernodes (424), and in particular trusted consolidation supernodes is that merchants that handle a great many different manufacturers and suppliers, such as Wal-Mart, Amazon.com, Google, and others may find it convenient to provide consolidation services to many manufacturers and suppliers, and further improve the efficiency of the system.

Although the examples in this specification have tended to be commercial examples where annotators have been the suppliers of goods and services pertaining to items of interest, it should be understood that these examples are not intended to be limiting. Many other applications are also possible. For example, consider the situation where the annotator is an encyclopedia or Wikipedia of general information. In this situation, nearly any object of interest can be annotated with non-commercial information as well. This non-commercial information can be any type of information (or misinformation) about the scene or item of interest, user comments and feedback, social network “tagging”, political commentary, humorous “pop-ups”, and the like. The annotation metadata can be in any language, and may also include images, sound, and video or links to other sources of text, images, sound and video.

### Other Variants of the Invention:

Security: As previously discussed, one problem with P2P networks is the issue of bogus, spoof, spam or otherwise unwanted annotation responses from illegitimate or hostile P2P nodes. As an alternative or in addition to the use of white-lists published by trusted supernodes, an annotation node may additionally establish that it at least has a relatively complete set of annotation regarding the at least one video by, for example, sending adjacent video signatures regarding future scenes or items on the at least one video media to the second user node for verification. This way the second user node can check on the validity of the adjacent video signatures, and at least verify that the first annotation node has a relatively comprehensive set of data regarding the at least one video media, and this can help cut down on fraud, spoofing, and spam.

In other variants of the invention, a website that is streaming a video broadcast may also choose to simultaneously stream the video annotation metadata for this broadcast as well, either directly, or indirectly via a P2P network.

1. A method of retrieving video annotation metadata stored on a plurality of annotation nodes on a Peer-to-Peer (P2P) network, any of said annotation nodes storing said video annotation metadata being capable of allowing retrieval of said video annotation metadata by a user, said method comprising:
annotator selecting image or sound portions of at least one video media, constructing a first annotation index that describes annotator selected portions, annotating said first index with annotation metadata, and making said first annotation index available for search on at least a first annotation node on said P2P network;
wherein said first annotation index is chosen to be distinct from all unique portions of said at least one video media, and wherein said first annotation index does not contain enough information to reproduce any unique portion of said at least one video media;
wherein said first annotation index is derived by computer analysis of annotator selected image or sound portions of said at least one video media;
wherein said annotation index and associated annotation metadata are distributed independently of a perfect or imperfect replica or portions of said at least one video media;
user viewing a perfect or imperfect replica media comprising images or sound from said at least one video media, user selecting at least one portion of images or sound of user interest of said replica media, and constructing a second user index that describes said at least one portion of images or sound of user interest of said replica media;
wherein said second user index is chosen to be distinct from all unique portions of said at replica media, and wherein said second user index does not contain enough information to reproduce any unique portion of said replica media;
sending said second user index across said P2P network as a query from a second user node on said P2P network;
receiving said second user index at said first annotation node on said P2P network, comparing said second user index with said first annotation index, and if said second user index and said first annotation index adequately match, retrieving said annotation metadata associated with said first annotation index, and sending at least some of said annotation metadata to said second user node.

2. The method of claim 1, in which said first annotation index and said second user index are produced by automatically analyzing at least selected portions of said at least one video media as whole and said replica media as a whole according to a first common mathematical algorithm;
said first common mathematical algorithm being based on image features that persist when the video media has a different resolution, frame count, noise, or is edited.

3. The method of claim 1, in which said annotator further selects specific portions of video images of said at least one video media, and said user further selects specific portions of video images of said at least one replica video media;
said first annotation index comprises a hierarchical annotation index that additionally comprises an annotation item signature representative of boundaries or other characteristics of annotator selected portions of annotator selected video image(s); and
said second user index additionally comprises a user item signature representative of boundaries or other characteristics of said user selected portion of said user selected replica video image(s).

4. The method of claim 3, in which said annotation item signature and said user item signature are produced by automatically analyzing boundaries or other characteristics of said annotator selected portions of said annotator selected video image(s) and automatically analyzing boundaries or other characteristics of said user selected portion of said user selected portion of said user selected replica video images according to a second common mathematical algorithm.

5. The method of claim 1, in which said annotation metadata is selected from the group consisting of product names, service names, product characteristics, service characteristics, product locations, service locations, product prices, service prices, product financing terms, and service financing terms.

6. The method of claim 1, in which said annotation metadata further comprises user criteria selected from the group consisting of user interests, user zip code, user purchasing habits, and user purchasing power;
said user transmits user data selected from the group consisting of user interests, user zip code, user purchasing habits, and user purchasing power across said P2P network to said first annotation node; and
said first annotation node additionally determines if said user data adequately matches said user criteria prior to sending at least some of said annotation metadata to said second user node.

7. The method of claim 1, in which said second user node resides on a network capable digital video recorder, personal computer, or video capable cellular telephone.

8. The method of claim 1, in which said second user node receives at least one white list of trusted first annotation nodes from at least one trusted supernode on said P2P network.

9. The method of claim 8, in which said trusted supernode additionally ranks said first annotation nodes according to priority, or in which said trusted supernode additionally charges said first annotation nodes for payment or micropayments.

10. The method of claim 1, wherein said first annotation index is produced using artificial image recognition methods that automatically identify object features in video images in said at least one video media, and use said object features to produce said annotation index;
and wherein said second user index is produced using artificial image recognition methods that automatically identify replica object features in video images in said replica media, and use said replica object features to produce said second user index.

11. A method of retrieving video annotation metadata stored on a plurality of annotation nodes on a Peer-to-Peer (P2P) network, any of said annotation nodes storing said video annotation metadata being capable of allowing retrieval of said video annotation metadata by a user, said method comprising:
setting up at least one trusted supernode on said P2P network,
using said at least one trusted supernode to designate at least one annotation node as being a trusted annotation node;
using said at least one trusted supernode to publish a white list of said at least one trusted annotation nodes that optionally contains properties of said at least one trusted annotation nodes;
annotator selecting image or sound portions of said at least one video media, constructing a first annotation index that describes annotator selected portions, annotating said first index with annotation metadata and optional annotation specific user criteria, and making said first annotation index available for search on at least a first trusted annotation node on said P2P network;
wherein said first annotation index is chosen to be distinct from all unique portions of said at least one video media, and wherein said first annotation index does not contain enough information to reproduce any unique portion of said at least one video media;
wherein said first annotation index is derived by computer analysis of annotator selected image or sound portions of said at least one video media;
wherein said annotation index and associated annotation metadata are distributed independently of a perfect or imperfect replica or portions of said at least one video media;
user viewing a perfect or imperfect replica media comprising images or sound from said at least one video media, user selecting at least one portion of images or sound of user interest of said replica media, and constructing a second user index that describes said at least one portion of images or sound of user interest of said replica media;
wherein said second user index is chosen to be distinct from all unique portions of said at replica media, and wherein said second user index does not contain enough information to reproduce any unique portion of said replica media;
sending said second user index across said P2P network as a query from a second user node on said P2P network, along with optional user data;
receiving said second user index at said first trusted annotation node on said P2P network, comparing said second user index with said first annotation index, and if said second user index and said first annotation index adequately match, and said optional user data adequately match annotation specific user criteria, then retrieving said annotation metadata associated with said first annotation index, and sending at least some of said annotation metadata to said second user node;
and using said white list to determine if at least some of said annotation metadata should be displayed at said second user node.

12. The method of claim 11, in which said properties of said at least one trusted annotation nodes include a priority ranking of said at least one trusted annotation node's annotation metadata.

13. The method of claim 12, in which said second user node receives a plurality of annotation metadata from a plurality of said at least one trusted annotation nodes, and in which said second user node displays said plurality of annotation metadata according to said priority rankings.

14. The method of claim 11, in which said optional user data and said annotation specific user criteria comprise data selected from the group consisting of user interests, user zip code, user purchasing habits, and user purchasing power.

15. The method of claim 11, wherein said first annotation index is produced using artificial image recognition methods that automatically identify object features in video images in said at least one video media, and use said object features to produce said annotation index;
and wherein said second user index is produced using artificial image recognition methods that automatically identify replica object features in video images in said replica media, and use said replica object features to produce said second user index.

16. A push method of retrieving video annotation metadata stored on a plurality of annotation nodes on a Peer-to-Peer (P2P) network, any of said annotation nodes storing said video annotation metadata being capable of allowing retrieval of said video annotation metadata by a user, said push method comprising:
annotator selecting image or sound portions of at least one video media, constructing at least a first annotation index that describes annotator selected portions, annotating said at least a first annotation index with annotation metadata, and making said at least a first annotation index available for download on at least a first annotation node on said P2P network;
wherein said first annotation index is chosen to be distinct from all unique portions of said at least one video media, and wherein said first annotation index does not contain enough information to reproduce any unique portion of said at least one video media;
wherein said first annotation index does not contain any portion of said video media, and said video media does not contain said first annotation index;
wherein said first annotation index is derived by computer analysis of annotator selected image or sound portions of said at least one video media;
wherein said annotation index and associated annotation metadata are distributed independently of a perfect or imperfect replica or portions of said at least one video media;
user viewing a perfect or imperfect replica of images or sound comprising replica media from said at least one video media, or user requesting to view images or sound from a perfect or imperfect replica of said at least one video media;
constructing a user media selection that identifies said at least one video media, and that additionally contains optional user data;
wherein said user media selection is chosen to be distinct from all unique portions of said at replica media, and wherein said user media selection does not contain enough information to reproduce any unique portion of said replica media;
sending said user media selection across said P2P network as a query from a second user node on said P2P network;
receiving said user media selection at said first annotation node or trusted supernode on said P2P network, comparing said user media selection with said at least a first annotation index, and if said user media selection and said at least a first annotation index adequately match, retrieving said at least a first annotation index and sending at least some of said at least a first annotation index to said second user node;
user selecting at least one portion of user interest of said replica media, and constructing at least a second user index that describes said at least one portion of user interest of said replica media;
comparing said at least a second user index with said at least a first annotation index, and if said at least a second user index and said at least a first annotation index adequately match, displaying at least some of said at least a first annotation metadata on said second user node.

17. The method of claim 16, in which a plurality of said first annotation indexes are sent to said second user node and are stored in at least one cache on said second user node prior to said user selecting of at least one portion of interest in said replica media.

18. The method of claim 16, in a plurality of said first annotation indexes are sent to a trusted supernode and are stored in at least one cache in said trusted supernode; and said trusted supernode sends at least some of said at least a first annotation index to said second user node.

19. The method of claim 16, in which said first annotation node or trusted supernode on said P2P network additionally streams a video signal of said perfect or imperfect replica of said at least one video media back to said second user node.

20. The method of claim 16, wherein said first annotation index is produced using artificial image recognition methods that automatically identify object features in video images in said at least one video media, and use said object features to produce said annotation index;
and wherein said second user index is produced using artificial image recognition methods that automatically identify replica object features in video images in said replica media, and use said replica object features to produce said second user index.
